(19) United States
(12) Patent Application Publication
(10) Pub. No.: US 2010/0139841 A1
(43) Pub. Date: Jun. 10, 2010

(54) METHOD FOR THE MANUFACTURE OF A CERAMIC COMPONENT

(75) Inventors: Stefan SIEGEL, Dresden (DE); Roland WEISS, Huttenberg (DE); Andreas LAUER, Kirchhain (DE); Gotthard NAUDITT, Huttenberg (DE)

Correspondence Address: DENNISON, SCHULTZ & MACDONALD, 1727 KING STREET, SUITE 105, ALEXANDRIA, VA, 22314, US

(73) Assignees: Fraunhofer-Gesellschaft zur Forderung der angewandten Forschung e. V., Munchen (DE); Schunk Kohlenstofftechnik GmbH, Heuchelheim (DE)

(21) Appl. No.: 12/626,746

(22) Filed: Nov. 27, 2009

(30) Foreign Application Priority Data
Nov. 26, 2008 (DE) 10 2008 037 591.8
Apr. 3, 2009 (EP) 09 15 7280.0

(51) Int. Cl. C04B 37/00

(52) U.S. Cl. 156/89.26; 156/89.25

(57) ABSTRACT

The invention relates to a method for the manufacture of a ceramic component of desired final geometry using at least a cellulose-containing semi-finished moulded part, which is pyrolysed in non-oxidizing gas atmosphere. In order to manufacture complex components, it is suggested that at least two semi-finished moulded parts are firmly joined either in raw form or after at least partial carbonisation. The joined moulded parts are subsequently machined to achieve the desired final geometry or a geometry corresponding to the desired final geometry plus the machining allowance. Then, the carbon parts are available after carbonisation of the moulded parts in non-oxidizing atmosphere. Alternatively, these can be converted into a CMC composite material in a non-oxidizing gas atmosphere by a metal infiltration process with simultaneous reactive joining of at least two moulded parts.

The invention relates to a method for the manufacture of a ceramic component or carbon component of desired final geometry using at least a cellulose-containing semi-finished moulded part, which is pyrolised in non-oxidising gas atmosphere.

A corresponding method for the manufacture of plate-shaped component exhibiting an even geometry can be seen in EP-B-1 453,773. A high-density fibre board with homogeneous distribution of the density over the diagonal board is used as semi-finished moulded part, which is then pyrolysed in such a manner that a desired density is achieved. Subsequently, a siliconisation takes place. A homogeneous wide ceramic component can be manufactured as mass-produced part by these measures.

The DE-A-198 23 507 refers to a method for the manufacture of moulded bodies on the basis of carbon, carbides and/or carbonitrides. Thereby, biogenous materials are used, which are converted into a mainly carbon-containing product by carbonisation, in order to subsequently to process to high-carbon-containing moulded bodies. Fibre composites in the form of non-woven web, mats or woven fabrics, that is long-fibre composite, as well as wide thin-walled planar formations are suggested as biogenous raw materials. Appropriate technical planar formations are subject to a crucial limitation in their use as carbon materials with mechanical function, since the carbon densities attainable for most applications are too small, so that the strength does not fulfil the requirements of mechanically high-stressable components. Such a product is used only with restrictions as carbon model for a reaction siliconising, since a high portion of free silicon in the final product causes definite limitations in the corrosion and high temperature behaviour.

The use of wood-like products as raw materials for economical SiC-ceramics, which are formed by means of a so-called “biocarbon preforms” through liquid phase siliconising, is known from “Krenkel: Biomorph SIC-ceramics from technical woods”, Symposium “Composite materials and material composites”, published by K. Schulte, K. Kainer, Wiley Publishing House Chemie Weinheim 1999 as well as “Low cost ceramics from wooden products”, Material Week, Munich 23-28 Sep. 2000. Experimentally, thereby, above all carbon bodies of pyrolysed veneered plywood is siliconised and converted into a C/SiC/Si-material.

A Method for the manufacture of a component of SiC-ceramic is given in DE-A-199 47 731. Thereby, a ceramic component is manufactured from cellulose-containing initial body by pyrolysis and subsequent infiltration with silicon. The initial body consists of a technical semi-finished material, which is formed from cellulose-containing material in the form of splinters and/or individual layers of laminar wood parts. Thereby, the structure of the semi-finished material is controlled by different ratios of cellulose-containing material and binding agent, whereby the binding agent content is more than 5%. A semi-finished material with a high portion of translaminar pore channels is produced by the layer formation and selection of the cellulose-containing material, which facilitates an infiltration with liquid silicon. This method is supported in case of a layer-wise developed semi-finished material still by crack formation during pyrolysis. A carbon perform is produced from this inhomogeneous, strongly porous structure, which can be utilized only for very restricted SiSiC-special applications. The resulting high portion of free Si in the final product restricts decisively both the mechanical characteristics and the corrosion- and high temperature behaviour.

It is known from the Japanese Patent JP-A-2001-048648, to manufacture a component on the basis of carbon using a lignocellulose-containing semi-finished moulding, which is pyrolysed under oxygen exclusion. The carbon mouldings exhibit less mechanical strength.

The WO-A-01/64602 refers to a ceramic component, which has been manufactured on the basis of a lignocellulose-containing semi-finished moulding. A less material density as well as inhomogeneities of structure and density result from the material composition and processing technology.

The German patent DE-C-39 22 539 discloses a method for the manufacture of high-precision heating elements of CFC, which suggests a pressed carbon textile fabric or wove carbon mono filament fibres as initial body. Thereby, there is the possibility of siliconising the pyrolised body.

JP-A-2026817 A refers to the manufacture of carbonisat boards on the basis of wood fibre.

The GB-A-1 346 735 refers to carbon components of post-impregnated cellulose-containing thin semi-finished products. Here, neither a siliconisation is addressed, nor a reference is made to a homogeneous density distribution or isotropic characteristics.

A ceramic component on the basis of a lignolcellulose-containing semi-finished moulding is indicated in the citation Greil, P: “Biomorphous ceramics from lignocellulosics”, Journal of the European Ceramic Society, Elsevier Science Publishers, Barking, Essex, GB, Bd. 21, No. 2, February 2001 (2001-02), Pages 105-118. Starting point are thereby monolithic natural woods and lignin-free cellulose precursors. Less material densities with high porosity allow only less mechanical characteristics.

Due to outstanding strength even at high temperatures, less density, high hardness and wear as well as excellent modulus of elasticity and corrosion resistance, a wide area of application opens up for ceramic materials in machine building and plant construction. The small coefficient of thermal expansion predestines ceramic structural components lightweight support functions under extreme climatic conditions and precision requirements.

Various applications in the area of optics, aeronautic engineering and space technology and in the special equipment manufacture are possible only by means of these structural ceramic inherent characteristics.

A still broader application is often limited by the costs of such complex structural components. The limited manufacturing possibilities stand in the way of high demand for such products. The typical powder-technology manufacturing processes in a chain over powder preparation, moulding and high temperature thermal treatments for debinding and sintering up to thermal and mechanical finish processes. Technically and economically, thereby very fast limits are reached, particularly if it concerns large and complex components like unique parts or small lot.

Generative manufacturing processes like the selective laser-internal or laminated object moulding are extremely complex and the products usually restricted in the mechanical output potential.

The manufacture of complex SI—SiC-components proved to be good by means of joint siliconising of individual modular components, which must be finish processed earlier narrow tolerances. This method is however very cost-intensive and practical only with restrictions.

The initially mentioned biogenous ceramic materials on the basis of regenerating plant raw materials proved to be an alternative to ceramics manufactured according to the methods described earlier. Thereby, the use of the board-type semi-finished material on wood fibre basis is found to be particularly favourable.

However, the ceramic structural components with three-dimensional dimensions greater than 10⁻¹ m can neither be manufactured economically by multiple layering of such fibre boards nor by injecting prepared natural fibre or their pyrolysis products.

An important obstacle of a defective-free carbonisation of wood raw forms, apart from structural inhomogeneities, is the necessity for stable exit paths for the pyrolysis waste products in particular in the form of gases. Cracks, delaminations and profile distortions appear already in case of component dimensions in the decimetre area in case of non-compliance.

The present invention is the based on the task to further develop a method of initially specified type in such a way that the process-technical limitations during the pyrolysis of plant fibre-containing raw forms can be avoided. At the same time however, the cost advantages are to be maintained, which can be achieved in the utilization of known raw material semi-finished products like fibre board semi-finished products.

In particular, bulk components are to be manufactured, without the cracks, delaminations or profile distortions occurring due to waste products like gas during the pyrolysis.

In order to resolve this task, the invention essentially provides that at least two semi-finished moulded parts are joined tightly either in semi-finished form or after at least partial carbonisation and that the joined moulded parts are processed for achieving the desired geometry or additionally an oversize of corresponding geometry and are available as carbon portion after carbonisation in non-oxidizing gas atmosphere and converted if necessary by a subsequent metal infiltration process during simultaneous reactive joining of at least two moulded parts into the ceramic component, thus a CMC (ceramic matrix composite)—composite material.

Based on the theories according to the invention, complex components can be manufactured by modular assembly of moulded parts, in order to make a desired complex composite component available. Thereby, the individual semi-finished moulded parts exhibit dimensions, which ensure that the waste products occurring during pyrolysis do not lead to crack formation, delaminations or profile distortions. Thereby, it in particular provided that the wall thickness D of the semi-finished moulded part amounts to: D≦160 mm, in particular D≦120 mm, preferably D≦50 mm.

It is particularly provided that the semi-finished moulded parts in the semi-finished state are firmly joined by means of an organic adhesive resin such as wood glue. Organic adhesive resins can be used expediently for joining, whose carbon yield during pyrolysis can be adapted by mixing of or several carbon carriers such as graphite, soot, pitch and/or pyrolysed fibres to the requirements of the following reactive ceramisation.

The firm joining of preferably at least partly carbonised, thus either not yet completely carbonised or completely carbonised moulded parts, is effected by means of adhesives and/or by impregnation. In particular, firm joining of moulded parts, which are assembled in modular form, takes place with resin-based carbon-containing adhesives, which can also be optimized by supplementing additives as for example graphite, soot, pitch and/or pyrolysed fibres with regard to their carbon level for the subsequent reactive ceramisation.

Further, it is provided that a matching of the pore structure takes place by means of joining agent like adhesive or impregnating medium facilitating the firm joining in the individual moulded parts. In particular, this happens due to the concerted carbon doping in the joining agents used.

The semi-finished material moulded parts can be impregnated with resins and/or other ceramic precursors, so that structures and final product characteristics of the ceramic component can be controlled as per the requirements. Thereby, the precursors are materials, which are converted by thermal treatment into ceramic material.

In a further development of the invention, it is suggested that such products are used as semi-finished product in their raw form, which exhibit an outline, which is roughly matched to the desired final geometry considering the contraction arising during the manufacture of the ceramic component.

In particular, it is intended that the assembled moulded parts after carbonisation are processed in final form geometry and/or almost final form geometry, whereby due to the soft carbon state of the assembled moulded parts, complicated geometrical outlines, undercuts, recesses, steps or threads or complex assembled forms can be produced.

Further, it is intended that the processing takes place in the carbon state to an extent that a final processing of the ceramic component is limited grinding to the most necessary functional surfaces such as sealing surfaces.

In particular, it is intended that MDF boards (medium density fibre boards) with apparent densities between 600 kg/m³ and 800 kg/m³ and/or HDF boards (high-density fibre boards) with apparent densities>800 kg/m³ are used as semi-finished moulded parts. Appropriate boards can be joined and subjected then to the process steps described earlier, in order to make a ceramic composite component available. It is in particular intended that in the semi-finished state, i.e. in the organic compacting condition, a rough outline increased by the later oscillation dimension is thus worked out.

An embodiment of the invention provides that the fibre boards are reduced in thickness, if necessary to avoid the density gradient unfavourable to a ceramisation, i.e. the denser surface areas are removed by machining.

Further, it is intended according to the invention that inorganic active components for carbide formation and/or development of later specific characteristics are introduced in the organic semi-finished moulded part by metallic and/or metal-organic additives to the pressable packing. The additives can be silicon, titanium, chromium, siloxane or Silazane, to name only exemplarily metallic and/or metal-organic additives, which are in the pressable packing as additive. The pressable packing is thereby the raw material, i.e. plant and wood fibres plus bonding agents.

According to the invention, there is the possibility to work out a rough outline increased by the later shrinking dimension already in the organic compacting state is already or to join suitable segments by sticking.

Complex structural components can be joined both in the wood- and unfinished state by wood adhesives and in the carbonised state (after possibly necessary intermediate processing) by carbon adhesives of individual system elements. Adding by sticking in the carbon state can be supported with measures of positive joining, in order to support the structure homogenization at the seam and avoid any delaminations.

The pyrolysis of the performs takes place under exclusion of air at temperatures>250° C. A complete carbonisation of the joined structural components requires temperatures>900° C. likewise again under exclusion of air, in order to be able to exclude unacceptable changes of geometry of the components machined to final dimension in the later siliconising. If necessary, a pre-carbonising can take place. After this, all content materials are not carbonised. Then, the joining takes place firmly and additionally if necessary positively. Subsequently, the appropriate module consisting of the joined moulded parts is completely carbonised.

Alternatively, joining can also be done after complete carbonisation of the moulded parts. Subsequently, a heat treatment is carried out again, in order to carbonise the joining agent.

Preferably, mechanical machining methods are used for final processing of the carbon forms. However, special methods like for example water jet cutting or laser machining are also suitable.

There is no change in volume or shape in case of subsequent reactive metal fusion infiltration or gaseous phase infiltrating into the finish machined carbon components.

Siliconisation methods are preferably named for the formation of Si—SiC—C-composite materials. In case of capillary method, Si-melt will infiltrate into the pore areas and reacts immediately with the carbon stand to silicon carbide. The siliconisation by means of Si-containing steam is to a large extent diffusion-controlled and requires correspondingly longer process times.

Surprising realization of the method according to invention is that despite serious differences in the structure of resin-based joining zone and vegetable fibre-based to joining partners, mechanically very stable and to a large extent structurally homogeneous ceramic components can be manufactured. A sufficient basis for a good quality of siliconising joint can be ensured by matching the pore structure in the individual components, partly also with measures of specific carbon doping in the adhesives used.

The decisive advantages of the manufacturing process according to the invention for complex ceramic compound systems are the use of economical wood-technological moulding method, suitable joining techniques by means of joining methods, the compound structures and above all a very effective working out of final geometry favouring the metal fusion infiltration process by the fibre morphology in the soft carbon state. Finish processing in the ceramic final state is limited to necessary functional surfaces.

The pyrolysis preceding the carbonisation should be carried out at a temperature between 250° C. and 800° C. The carbonisation takes place at a temperature of at least 1000° C., in particular from at least 1100° C.

During pyrolysis and/or carbonisation of the joined semi-finished moulded parts, heating takes place in rates between 1K/h to 1K/min., in particular less 0.1 K/min.

In particular, the invention marks a method for the manufacture of a ceramic composite material and a composite components based on it, in which preformed semi-finished products of resin-bound plant fibres are used as raw material, from which manufactured raw forms with wood adhesives joined or not joined are carbonised at temperatures>800° C., brought to the final geometry by possible additional sticking/joining processes or impregnation processes in the carbon state and after a complete carbonisation at temperatures>1000° C. by machining in the carbon state considering necessary grinding tolerances for the ceramic finish process and then made available as carbon products or are transformed by a subsequent metal infiltration process under exclusion of air into a CMC-composite material with simultaneous reactive joining of the modular developed ceramic component.

Further details, advantages and characteristics of the invention are evident not only from the claims, which are to be inferred from these characteristics—for itself and/or in combination—, but also from the following description of the drawing with preferred embodiments.

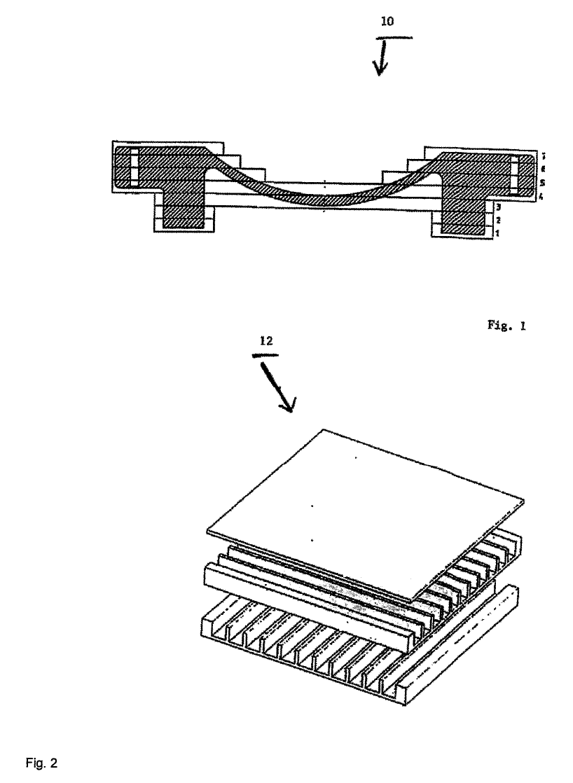

FIG. 1 A composite component in the form of a spherical reflector and

FIG. 2 A heat exchanger module.

As example 1, below the theories according to the invention are described in detail with a adjusting segment for exposure optics.

Adjusting segments for exposure optics have to meet extreme requirements with regard to high structural rigidity and low thermal coefficients of expansion, which cannot be fulfilled any more by the metallic materials.

Here, ceramic materials present a solution to the problem. In case of larger components, however substantial costs arise, which can be distinctly reduced with the methods according to the invention. Additionally, new positioning- and adjusting possibilities are obtained, since for example thread, joining supports and offset bores can be machined already in the carbon state according to the invention.

In the present example 1, a positioning unit of the dimensions 150 mm×150 mm×20 mm on the basis of medium-density wood fibre boards MDF was manufactured. In addition, two boards MDF 210 mm×210 mm×22 mm are joined with each other by an organic wood adhesive, enriched with 10 wt.-% graphitic powder. Earlier, a circular disk diameter of 110 mm was cut out from the individual boards, which form later a cylindrical central opening of diameter 90 mm as circular objective attachment. The pasted composite material was carbonised after air hardening under nitrogen at 1150° C. Each fibre board and thus the entire component in the board plane shrink by 23%, in height by 42%. The carbon component is obtained by milling to final geometry. Functionally necessary through-holes and threads are bored. The carbon density of 0.62 g/cm³ attained is suitable for a siliconisation. This is carried out as capillary infiltration with liquid silicon at 1600° C. under argon atmosphere.

At the siliconised component, only still functionally crucial sealing surfaces are to be reground with diamond tools. A static modulus of elasticity of 320 GPa is achieved in case of a 4-point-flexural strength of 280 MPa. The thermal linear coefficient of expansion with 2.9×10⁻⁶ K⁻¹ likewise meets the requirements.

The method according to the invention is explained in detail by means of the complex composite components in form of a spherical reflector 10 (FIG. 1) represented in the figures and a heat exchanger module 12 (FIG. 2). Thereby, the process steps are considered, which have been described in the example described earlier.

### Example 2

### (Spherical Reflector 10):

As study for a ceramic radiation reflector, a Si—SiC-light-weight concept was implemented on the basis of MDF-boards. With consideration of the pyrolysis contractions specified in Example 1, annular and circular board elements MDF 22 mm were stuck according to the concept of FIG. 1 in 7 board planes with wood adhesive and carbonised up to 1700° C. The geometry Ø320 mm×90 mm so obtained from seven even board elements 1-7 is milled to final dimension in the carbon state. Only the later spherical reflector surface got as grinding tolerance a radius less by 0.5 mm. Holes for fastening elements and structurally important steps were supplemented.

The ceramisation took place as Si-fusion infiltration at 1650° C. in argon atmosphere. Material densities of 2.90 g/cm³ are reached without provable open porosity.

The grinding took place after the ceramisation, in order to remove the excess material on the reflector surface

### Example 3

(ceramic Heat Exchanger 12):

Ceramic heat exchangers are for many years an object of development. The composite material SiSiC is particularly promising due to its heat conductivity. Problem of many manufacturing attachments are the necessary component dimensions, gas-tight joints and lastly the substantial production costs.

The solution according to the invention provides a modular type structure as per FIG. 2. For prototypes MDF-boards 150 mm×150 mm×16 mm were carbonised at 1150° C. under nitrogen atmosphere, whereby densities of 0.64 g/cm³ are achieved. From this, the individual planes of the heat exchanger as per FIG. 2 are milled with retaining support frames and rotated alternately by 90° and joined to a total block of each 2×6 channel levels by means of carbon adhesive.

After pyrolysis of the adhesive at 900° C. under nitrogen atmosphere, the overall system is ceramised by silicon melt at 1650° C. under argon and thereby firmly bonded. Due to high Si-portion in the structure, only densities 2.70 to 2.80 g/cm³ is realised in case of a remainder porosity of 4 to 6%.

The hot exhaust air flow in such a heat exchanger cube of 106 mm×106 mm×106 mm heats up the fresh air flow, shifted by 90°, entering into the respective intermediate levels. The strict separation of both gas flows is ensured by laterally gas-tight incident flow hoods.

1. Method for the manufacture of a ceramic component or a carbon component of desired final geometry using at least a cellulose-containing semi-finished moulded part, which is pyrolysed in non-oxidizing gas atmosphere, characterized by the fact that at least two semi-finished moulded parts are firmly bonded either in rough form or after at least partial carbonisation that the joined moulded parts help achieving the desired final geometry or an appropriate geometry machined to the final geometry plus machining allowance and available as carbon component after carbonisation in non-oxidizing gas atmosphere or are converted by a following metal infiltration process with simultaneous reactive joining of at least two moulded parts into a CMC-composite material.

2. Method according to claim 1, wherein firm joining of the semi-finished moulded parts is accomplished in the rough state by means of an organic adhesive resin such as wood glue.

3. Method according to claim 2, wherein carbon carrier such as graphite, soot, pitch and/or pyrolysed fibres is added to the adhesive resin.

4. Method according to claim 2, wherein an adhesive resin with carbon carriers added if necessary is used for joining, whose carbon yield with pyrolysis and/or carbonisation is matched to the requirements of the reactive ceramisation.

5. Method according to claim 1, wherein at least partly carbonised moulded parts are joined by sticking and/or impregnating using carbon-containing bonding agents.

6. Method according to claim 1, wherein a resin-based carbon-containing adhesive is used for firm joining of at least two moulded parts after at least partial carbonisation.

7. Method according to claim 6, wherein the adhesive used for joining of preferably at least partly carbonised moulded parts is set by supplementing additives such as graphite, soot, pitch and/or pyrolysed fibres with regard to carbon yield for the reactive ceramisation.

8. Method according to claim 1, wherein silicon is used for the metal infiltration process and/or that metallic carbide forming agents separately or in mixture are introduced for the metal infiltration process and/or that the metal infiltration process is carried out by means of capillary-controlled liquid infiltration and/or metal vapour-containing gas atmosphere.

9. Method according to claim 1, wherein such products are used as semi-finished product In their rough form, which exhibit an outline, which is roughly matched to desired final geometry considering the shrinkage occurring during the manufacture of the ceramic component.

10. Method according to claim 1, wherein the pyrolysis preceding the carbonisation is carried out at a temperature T_{B} with 250° C.≦T_{B}≦800° C. and/or that the carbonisation is carried out at a temperature T_{V} with T_{V}≧1000° C., in particular T_{V}≧1100° C.

11. Method according to claim 1, wherein the joined semi-finished moulded parts are heated up in steps from 1k/h to 1K/min, in particular by less than 0.1 K/min during pyrolysis and/or carbonisation and/or that during the metal infiltration heating of the moulded parts is carried out in steps of 3 K/min to 7 K/min, in particular by in approximately 5 K/min, whereby in particular in the metal infiltration after attaining the final temperature, this is retained over period of t with 20 min.≦t≦40 min., in particular t in approximately 30 min.

12. Method according to claim 1, wherein the preferably modular joined semi-finished moulded parts exhibit maximum wall thickness D with D≦160 mm, in particular D≦120 mm, preferably D≦50 mm.

13. Method according to claim 1, wherein the cellulose-containing semi-finished moulded part consists of at least a resin-containing bonding agent and at least a raw material of plant- and/or wood fibres.

14. Method according to claim 1, wherein as semi-finished moulded part a medium-density wood fibre board (MDF) with apparent densities between 600 kg/m³ and 800 kg/m³ and/or a high-density (HOF) fibre board with apparent densities≧800 kg/m³ are used, whereby in particular material is removed from the surface areas of the of the wood fibre boards, whose density is greater than the mean density of the wood fibre board.

15. Method according to claim 1, wherein the semi-finished material moulded parts are controlled with resins and/or other ceramic precursors structure and final product characteristics by impregnation as per the requirements, and/or the component geometry and material structure are specifically controlled by joining processes and/or impregnating processes of at least partly, in particular completely carbonised moulded parts.

16. Method according to claim 1, wherein after at least partial carbonisation, in particular after complete carbonisation of the joined moulded parts, the desired geometry, rear-cutting, recesses, steps and/or threads as per the end form or almost as per the end form are worked out.

17. Method according to claim 1, wherein a final machining of the ceramic component is limited by grinding to necessary functional surfaces such as sealing surfaces.

18. Method according to claim 1, wherein inorganic effect components for carbide formation and/or development of later specific characteristics of the ceramic component are introduced into the semi-finished moulded part through metallic or metal-organic additives to the pressable packing.

19. Methods for the manufacture of a ceramic composite material and composite components based on it, in which prefabricated semi-finished products of resin-bound plant fibres are used as raw material, the unfinished forms manufactured from it joined with wood adhesives or released at temperatures>800° C. are carbonised, by possible additional sticking-/joining processes or impregnating processes in the carbon state and after a full carbonisation at temperatures>1000° C. by machining in the carbon condition considering necessary grinding tolerances for the ceramic finish process to final geometry and then are available as carbon products or are converted into a CMC-composite material by a subsequent metal infiltration process under air exclusion with simultaneous reactive joining of the modular structured ceramic component.
